(19) United States
(12) Patent Application Publication
(10) Pub. No.: US 2007/0139290 A1
(43) Pub. Date: Jun. 21, 2007

(54) RFID tag and RFID system having the same

(75) Inventors: Il-jong Song, Suwon-si (KR); Yuri Tikhov, Suwon-si (KR); Young-hoon Min, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/489,634

(22) Filed: Jul. 20, 2006

(30) Foreign Application Priority Data
Dec. 15, 2005 (KR) 10-2005-0124209

(51) Int. Cl. H01Q 1/50; G08B 13/14; H01Q 9/16

(52) U.S. Cl. 343/860; 340/572.7; 343/822

(57) ABSTRACT

A radio frequency identification tag (RFID) that extends a read range of an RFID reader, and an RFID system including the RFID tag. The RFID tag includes a tag antenna, an IC, and a bonding part electrically connecting the tag antenna to the IC. A complex conjugate of an impedance of the tag antenna is a value obtained by adding an impedance of the IC to an impedance of the bonding part. Thus, the RFID tag can achieve accurate impedance matching between the tag antenna and the bonding, smoothly perform data communication with the RFID reader, and extend the read range of the RFID reader.

### CROSS-REFERENCE TO RELATED APPLICATIONS

This application claims priority from Korean Patent Application No. 2005-124209, filed Dec. 15, 2005, in the Korean Intellectual Property Office, the disclosure of which is incorporated herein by reference.

### BACKGROUND OF THE INVENTION

1. Field of the Invention

The present invention relates to a radio frequency identification (RFID) tag, and more particularly, to an RFID tag for accurate impedance matching between the RFID tag and an RFID reader.

2. Description of the Related Art

RFID is automatic identification technology using a radio frequency (RF), i.e., new technology representative of a contactless integrated circuit (IC) card, that replaces a barcode and a magnetic card.

An RFID system includes an RFID reader, a host computer, and a transponder, i.e., an RFID tag. The RFID reader includes an antenna transmitting electromagnetic waves. The RFID tag stores identifiers (IDs) assigned to RFID tags and predetermined data to identify the RFID tags. If the RFID tag is positioned within a magnetic field or an electrical field of the RFID reader, the RFID tag transmits the IDs and the predetermined data to the RFID reader. The RFID reader transmits the IDs and the predetermined data received from the RFID tag to the host computer, and the host computer stores the IDs and the predetermined data.

Such an RFID system removes defects of an existing barcode and an automatic identifying apparatus and has been widely applied to provide convenience of use, and improvement of a producing method, culture and technology. Also, the RFID system has been applied to distribution and logistics systems.

Impedance matching between an RFID reader and an RFID tag must be considered during manufacturing of the RFID tag. If the impedance matching between the RFID reader and the RFID tag is not accurately achieved, reflected signals are increased. Thus, transmission and reception of data between the RFID reader and the RFID tag are not smoothly performed. Also, an identification range for receiving a minimum power for operating the RFID tag is reduced.

As described above, impedance matching between an antenna and an integrated circuit (IC) of the RFID tag must be accurately achieved for smooth transmission and reception of data between the RFID reader and the RFID tag. Thus, an impedance of the antenna of the RFID tag is calculated in consideration of an impedance of the IC during designing of the RFID tag, and the RFID tag is designed using the calculated impedance.

However, the impedance occurring in the RFID tag includes impedances of the antenna and the IC and a bonding impedance caused by a combination of the antenna and the IC. The bonding impedance is a kind of parasitic impedance that is not considered during the designing of the RFID tag.

The bonding impedance is a factor of increasing the impedance of the RFID tag. Thus, the impedance of the RFID tag is different from an impedance expected during the designing of the RFID tag. As a result, the impedance matching between the RFID reader and the RFID tag is not accurately achieved, and thus the RFID system reduces a range of the RFID reader for identifying the RFID tag and does not smoothly transmit and receive data.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non- limiting embodiment of the present invention may not overcome any of the problems described above

The present invention provides an RFID tag capable of extending a read range of an RFID reader and an RFID system including the RFID tag.

According to an aspect of the present invention, there is provided an RFID (radio frequency identification) tag transmitting a signal to and/or receiving a signal from an RFID reader by wireless using a specific frequency band, including: a tag antenna part including at least one or more tag antennas transmitting the signal to and/or receiving the signal from the RFID reader; an IC (integrated circuit) electrically connected to the tag antenna part to transmit the signal to and/or receive the signal from the tag antenna part; and a bonding part electrically connecting the tag antenna part to the IC. A complex conjugate of an impedance of the tag antenna part may be an impedance obtained by adding an impedance of the IC to an impedance of the bonding part.

The bonding part may include at least one or more bonding bumps bonding the tag antenna part to the IC.

A sum of the impedances of the IC and the bonding part may satisfy the equation below:

$$\frac{1}{( Z2 + Z 3 )} = \frac{1}{R 1 - jX 1} + \frac{1}{- jX 2}$$

$$Z 2 + Z 3 = \frac{( R 1 - jX 1 ) ( - jX 1 )}{- jX 2 + ( R 1 - jX 1 )} = \frac{X 1 X 2 + R 1 X 2 j}{- R 1 + ( X 1 + X 2 ) j}$$

$$RZ = \frac{( R 1 ) ( X {2}^{2} )}{R {1}^{2} + {( X 1 + X 2 )}^{2}}$$

$$Im Z = \frac{- X 2 ( R {1}^{2} + ( X 1 ) ( X 1 + X 2 ) )}{R {1}^{2} + {( X 1 + X 2 )}^{2}}$$

wherein Z2 denotes the impedance of the IC, Z3 denotes the impedance of the boding part, (R−jX1) denotes the impedance of the IC, (−jX2) denotes the impedance of the bonding part, RZ denotes a real impedance of an impedance obtained by adding the impedances of the IC to the bonding part, and ImZ denotes an imaginary impedance of the impedance obtained by adding the impedances of the IC to the impedance of the bonding part.

The bonding part may include at least one or more wires connecting the antenna part to the IC.

The sum of the impedances of the IC and the bonding part may satisfy the equation below:
Z2+Z3=(R1−jX1)+(R2+jX2)
RZ=R1+R2
ImZ=−(X1−X2)
wherein Z2 denotes the impedance of the IC, Z3 denotes the impedance of the bonding part, (R1−jX1) denotes the impedance of the IC, (R2+jX2) denotes the impedance of the bonding part, RZ denotes the real impedance of the impedance obtained by adding the impedances of the IC to the bonding part, and ImZ denotes the imaginary impedance of the impedance obtained by adding the impedances of the IC to the impedance of the bonding part.

The bonding part may include: a bonding bump part including at least one or more bonding bumps; and a wire part including at least one or more wires.

The sum of the impedances of the IC and the bonding part may satisfy the equation below:

$$Z 2 + Z 3 = \frac{[ ( R 1 - jX 1 ) + ( R 3 - jX 3 ) ] - jX 4}{- jX 4 + ( R 1 - jX 1 ) + ( R 3 + jX 3 )}$$

$$RZ = \frac{( R 1 + R 3 ) X {4}^{2}}{{( R 1 + R 3 )}^{2} + {( X 1 - X 3 + X 4 )}^{2}}$$

$$Im Z = \frac{- X 4 [ {( R 1 + R 3 )}^{2} ( X 1 - X 3 ) ( X 1 - X 3 + X 4 ) ]}{{( R 1 + R 3 )}^{2} + {( X 1 - X 3 + X 4 )}^{2}}$$

wherein Z2 denotes the impedance of the IC, Z3 denotes the impedance of the bonding part, R1−jX1) denotes the impedance of the IC, (R3−jX3) denotes an impedance of the wire part, (−jX4) denotes an impedance of the bonding bump part, RZ denotes a real impedance of an impedance obtained by adding the impedances of the IC to the bonding part, and ImZ denotes an imaginary impedance of the impedance obtained by adding the impedances of the IC to the impedance of the bonding part.

According to another aspect of the present invention, there is provided an RFID system including: an. RFID reader transmitting a signal by wireless using a specific frequency band; and an RFID tag including a tag antenna part including at least one or more tag antennas transmitting the signal to and/or receiving the signal from the RFID reader, an IC electrically connected to the tag antenna part to transmit the signal to and/or receiving the signal from the tag antenna part, and a bonding part electrically connecting the tag antenna part to the IC. A complex conjugate of an impedance of the tag antenna part may be an impedance obtained by adding an impedances of the IC to an impedance of the bonding part.

### BRIEF DESCRIPTION OF THE DRAWINGS

The above and/or other aspects of the present invention will be more apparent by describing certain embodiments of the present invention with reference to the accompanying drawings, in which:

FIG. 1 is a block diagram of an RFID system according to an exemplary embodiment of the present invention;

FIG. 2 is a partial plan view of an RFID tag shown in FIG. 1;

FIG. 3 is a cross-sectional view taken along line I-I′ of FIG. 2;

FIG. 4 is a circuit diagram of the RFID tag shown in FIG. 2;

FIG. 5 is a detailed circuit diagram of a chip/bonding part shown in FIG. 3;

FIG. 6 is a partial plan view of an RFID tag according to another exemplary embodiment of the present invention;

FIG. 7 is a circuit diagram of a chip/bonding part of the RFID tag shown in FIG. 6; and

FIG. 8 is a circuit diagram of an RFID tag according to another exemplary embodiment of the present invention.

### DETAILED DESCRIPTION OF EXEMPLARY EMBODIMENTS OF THE INVENTION

Exemplary embodiments of the present invention will be described in greater detail with reference to the accompanying drawings.

In the description of the exemplary embodiments, same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well known functions or constructions are not described in detail since they would obscure the invention in unnecessary detail.

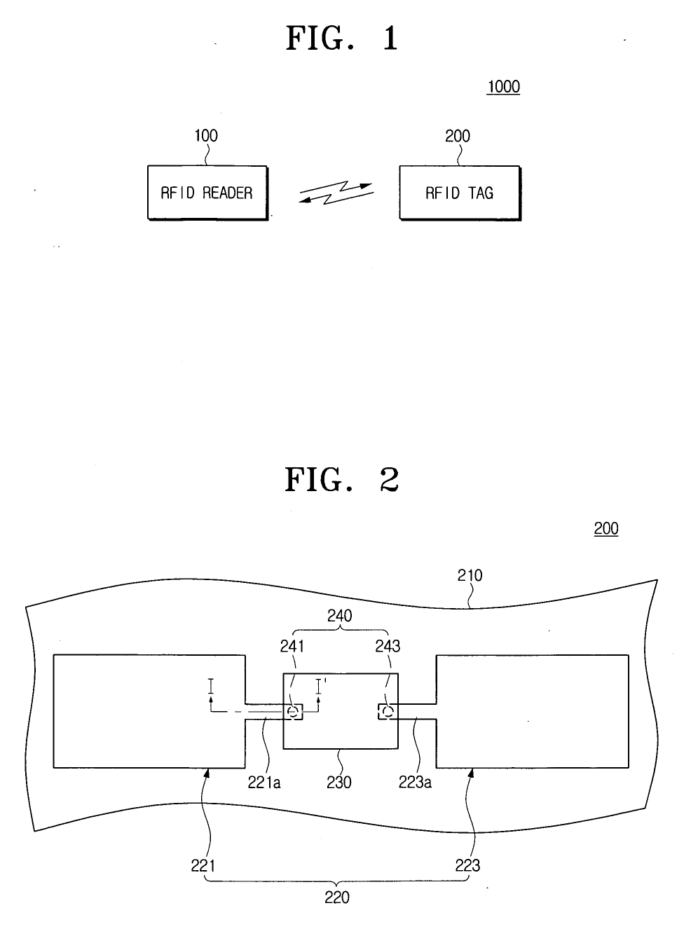

FIG. 1 is a block diagram of an RFID system according to an exemplary embodiment of the present invention. Referring to FIG. 1, an RFID system 1000 includes an RFID reader 100 and an RFID tag 200.

In detail, the RFID reader 100 includes an antenna (not shown) transmitting electromagnetic waves and uses an RF to transmit data to and/or receive data from the RFID tag 200.

The RFID tag 200 stores IDs assigned to RFID tags and predetermined data to identify the RFID tags. If the RFID tag 200 is positioned within a magnetic field, i.e., a read range of the RFID reader 100 reading the RFID tag 200, the RFID tag 200 receives the electromagnetic waves from the RFID reader 100. If the RFID tag 200 receives the electromagnetic waves from the RFID reader 100, the RFID tag 200 transmits the IDs and the predetermined data to the RFID reader 100. The RFID reader 100 transmits the IDs and the predetermined data to a host computer (not shown), and the host computer stores the IDs and the predetermined data.

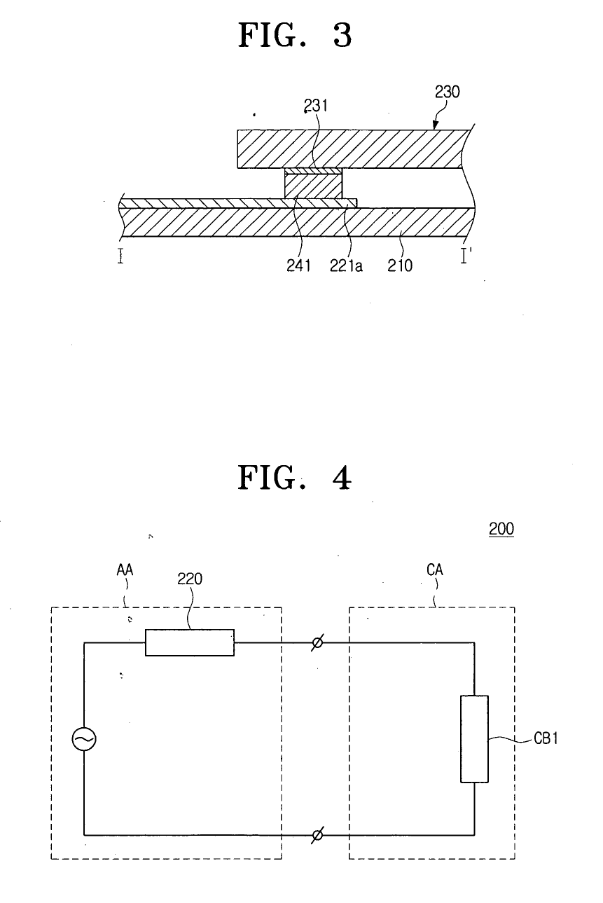

FIG. 2 is a partial plan view of the RFID tag 200 shown in FIG. 1, and FIG. 3 is a cross-sectional view taken along line I-I′ of FIG. 2. Referring to FIGS. 2 and 3, the RFID tag 200 includes a base substrate 210, a tag antenna 220, an IC 230, and a bonding bump 240.

In detail, the base substrate 210 is formed of an insulating material such as Poly Ethylene Terephthalate (PET).

The tag antenna 220 is positioned on the base substrate 210, and receives the electromagnetic waves, i.e., a voltage, to provide the electromagnetic waves to the IC 230, and receives the IDs and the predetermined data from the IC 230 to transmit the IDs and the predetermined data to the RFID reader 100.

The tag antenna 220 includes first and second tag antennas 221 and 223. In the present exemplary embodiment, the RFID tag 200 includes two antennas 221 and 223. However, a number of tag antennas may be increased or decreased when designing the RFID tag 200.

The first and second tag antennas 221 and 223 respectively include antenna electrodes 221a and 223a electrically connected to the IC 230.

The IC 230 is mounted on the base substrate 210 and stores the IDs and the predetermined data. The IC 230 includes leads electrically connected to the first and second tag antennas 221 and 223. The leads are positioned on a rear surface of the IC 230.

The bonding bump 240 is interposed between the IC 230 and the tag antenna 220 so as to fix the IC 230 to the tag antenna 220. Here, the bonding bump 240 includes two bonding bumps 241 and 243. However, a number of bonding bumps may be increased or decreased with a number of leads 231.

In the present embodiment, combination relationships among the tag antenna 220, the IC 230, and the first and second bonding bumps 241 and 243 are the same. Thus, the combination relationships among the tag antenna 220, the IC 230, and the first and second bonding bumps 241 and 243 will be described in detail by taking combination relationships among the first tag antenna 221, the IC 230, and the first bonding bump 241 as an example.

As shown in FIG. 3, the first bonding bump 241 is interposed between the antenna electrode 221a of the first antenna tag 221 and the first lead 231 of the IC 230. The first bonding bump 241 couples the first lead 231 of the IC 230 to the first antenna tag 221 so as to fix the IC 230 to the first tag antenna 221 and electrically connect the first lead 231 of the IC 230 to the antenna electrode 221 a of the first antenna tag 221.

Here, the first bonding bump 241 may be formed of a conductive metal material. In a case where the first bonding bump 241 is formed of conductive metal material, the first bonding bump 241 may package the IC 230 in the first tag antenna 221 using a bonding method to electrically connect the IC 230 to the first tag antenna 221. Also, the first bonding bump 241 may be formed of an adhesive conductive material such as an anisotropic conductive film (ACF). In a case where the first bonding bump 241 is formed of the adhesive conductive material, the first bonding bump 241 may adhere the IC 230 to the first tag antenna 221 to electrically connect the IC 230 to the first tag antenna 221.

As described above, the bonding bump 240 fixes a position of the IC 230 and electrically connects the IC 230 to the tag antenna 220. As a result, the IC 230 can transmit data to and/or receive data from the RFID reader 100 through the tag antenna 220.

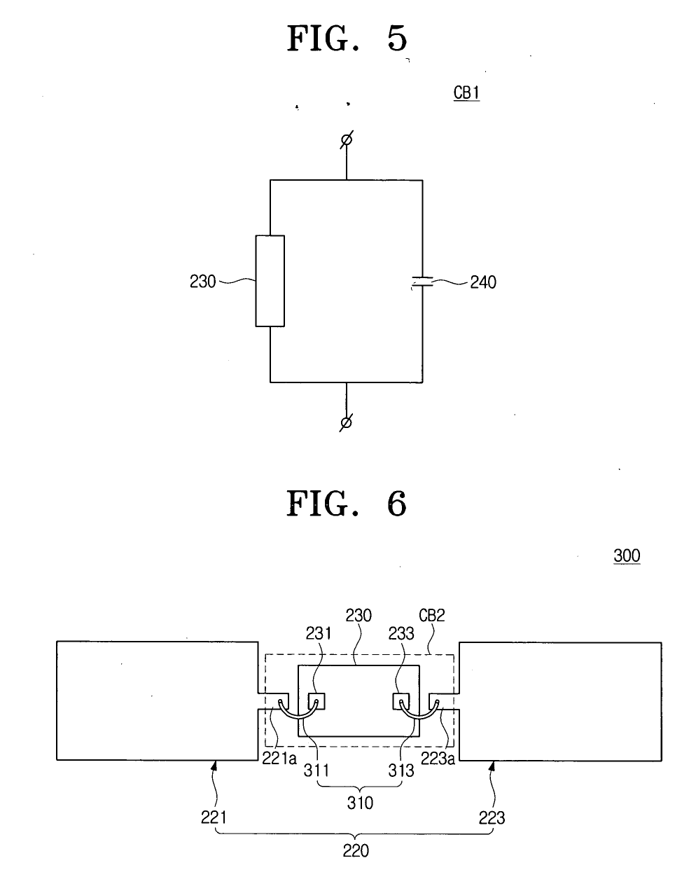

FIG. 4 is a circuit diagram of the RFID tag 200 shown in FIG. 2, and FIG. 5 is a detailed circuit diagram of a chip/bonding part shown in FIG. 3. Referring to FIGS. 4 and 5, a circuit part of the RFID tag 200 is divided into an antenna area AA including the tag antenna 220 and a chip area CA except the antenna area AA.

The chip area CA is electrically connected to the tag antenna 220 and includes a chip/bonding part CB1 receiving power from the tag antenna 220. The chip/bonding part CB1 includes the IC 230 and the bonding bump 240. Here, the bonding bump 240 is electrically connected to the tag antenna 220 and the IC 230 and thus operates as a kind of capacitor.

An impedance of the RFID tag 200 is an impedance obtained by adding an impedance of the tag antenna 220 to an impedance of the chip/bonding part CB1. In the RFID tag 200, the tag antenna 220 functions as a kind of inductor, and the chip/bonding part CB1 functions as a kind of capacitor. Thus, the impedance of the tag antenna 220 is a complex conjugate of the impedance of the chip/bonding part CB1, impedance matching between the tag antenna 220 and the chip/bonding part CB1 can be accurately achieved. A relationship between the impedances of the tag antenna 220 and the chip/bonding part CB1 is expressed as in Equation 1:
Z*=Impedance of Chip/Bonding Part=Impedance of Tag Element+Impedance of Bonding Bump (1)
wherein Z denotes the impedance of the tag antenna 220.

Referring to Equation 1, when the complex conjugate of the impedance Z of the tag antenna 220 is the impedance of the chip/bonding part CB1, an imaginary impedance of the tag antenna 220 is offset by an imaginary impedance of the chip/bonding part CB1. Thus, the impedance matching between the tag antenna 220 and the chip/bonding part CB1 is accurately achieved, and thus power efficiency of the RFID tag 200 can be improved.

The impedance of the chip/bonding part CB1 is an impedance obtained by adding an impedance of the IC 230 to an impedance of the bonding bump 240. The IC 230 is connected to the bonding bump 240 in parallel, and thus a process of calculating the impedance of the chip/bonding part CB1 is expressed as in Equation 2.

$$\begin{matrix}\frac{1}{\begin{matrix}( Impedance of Tag Element ) + \\ ( Impedance of Bonding Bump )\end{matrix}} = \frac{1}{R 1 - jX 1} + \frac{1}{- jX 2} \\ = \frac{- jX 2 + R 1 - jX 1}{( R 1 - jX 1 ) ( - jX 2 )} \\ = \frac{R 1 - ( X 1 + X 2 ) j}{- jR 1 X 2 - X 1 X 2} \\ = \frac{- R 1 + ( X 1 + X 2 ) j}{X 1 X 2 + R 1 X 2 j}\end{matrix} \\ \begin{matrix}\begin{matrix}( Impedance of Tag Element ) + \\ ( Impedance of Bonding Bump )\end{matrix} = \frac{X 1 X 2 + R 1 X 2 j}{- R 1 + ( X 1 + X 2 ) j} \\ = \frac{ [ X 1 X 2 + R 1 X 2 j ] \\ [ - R - ( X 1 + X 2 ) j ]}{[ - R + ( X 1 + X 2 ) j ] \\ [ - R - ( X 1 + X 2 ) j ]} \\ = \frac{\begin{matrix} ( - R 1 X 1 X 2 ) - \\ ( X 1 X 2 ( X 1 + X 2 ) j ) - \\ ( R {1}^{2} X 2 j ) + \\ ( R 1 X 2 ( X 1 + X 2 ) )\end{matrix}}{R {1}^{2} + {( X 1 + X 2 )}^{2}} \\ = \frac{ {( R 1 X 2 )}^{2} - \\ ( - {X}^{2} ( X {1}^{2} + X 1 X 2 + R {1}^{2} ) ) j}{R {1}^{2} + {( X 1 + X 2 )}^{2}}\end{matrix} \qquad ( 2 )$$

wherein (R1−jX1) denotes the impedance of the IC 230, and (−jX2) denotes the impedance of the bonding bump 240.

A real impedance and an imaginary impedance of the chip/bonding part CB1 calculated as in Equation 2 can be expressed as in Equation 3:

$$Real Impedance = \frac{( R 1 ) {( X 2 )}^{2}}{R {1}^{2} + {( X 1 + X 2 )}^{2}} \\ Imaginary Impedance = \frac{- X 2 ( R {1}^{2} + X 1 ( X 1 + X 2 ) )}{R {1}^{2} + {( X 1 + X 2 )}^{2}} \qquad ( 3 )$$

As described above, the impedance Z of the tag antenna 220 is determined in consideration of the impedance of the IC 230 and a parasitic impedance generated by the bonding bump 240, i.e., the impedance of the bonding bump 240. That is, the tag antenna 220 according to the present invention is designed in consideration of the impedance of the chip/bonding part CB1 for accurate impedance matching between the tag antenna 220 and the chip/bonding part CB1. Since the RFID tag 200 includes the tag antenna 200 designed through such a process, impedance matching between the tag antenna 220 and the chip/bonding part CB1 can be accurately achieved. Thus, the reflected signals generated between the RFID tag 200 and the RFID reader 100 can be decreased. As a result, the read range of the RFID reader 100 can be extended.

The impedance matching between the RFID reader 100 and the RFID tag 200 and the read range of the RFID reader 100 will now be described in detail with reference to Equation 4.

The read range of the RFID reader 100 may be calculated using Equation 4:

$$Read Range = \frac{λ}{4 π } \sqrt{\frac{Pt}{Pth} ( G t ) ( Gr ) τ} \qquad ( 4 )$$

wherein Pt denotes an input power transmitted from the RFID reader 100 to the RFID tag 200, Gt denotes a gain of an antenna of the RFID reader 100, Gr denotes a gain of the tag antenna 220, and Pth denotes a minimum operation power the IC 230 requires to operate the RFID tag 200 except the input power supplied from the RFID reader 100.

Referring to Equation 4, as the minimum operation power Pth is low, the read range of the RFID reader 100 is extended. The impedance matching between the RFID reader 100 and the RFID tag 200 must be accurately achieved to minimize the minimum operation power Pth.

That is, the reflected signals between the RFID reader 100 and the RFID tag 200 are decreased to accurately achieve the impedance matching between the RFID reader 100 and the RFID tag 200. Thus, use efficiency of a consumed power of the RFID system 1000 is improved. As a result, since the RFID system 1000 can drive the IC 230 of the RFID tag 200 at a minimum power, the minimum operation power Pth of the IC 230 can be reduced, and thus the read range of the RFID reader 100 can be extended.

As described above, the RFID tag 200 according to the present invention can include the tag antenna 220 designed in consideration of a parasitic impedance such as the impedance of the bonding bump 240. Thus, the impedance matching between the RFID reader 100 and the RFID tag 200 can be accurately achieved. As a result, the RFID system 1000 can improve the use efficiency of the consumed power and thus extend the read range of the RFID reader 100.

FIG. 6 is a partial plan view of an RFID tag according to another exemplary embodiment of the present invention. Referring to FIG. 6, an RFID tag 300 according to the present embodiment has the same structure as the RFID tag 200 shown in FIG. 2 except for the addition of wire 310. The same reference numerals of the RFID tag 300 as those of the RFID tag 200 shown in FIG. 2 denote like elements and thus, will not be described herein.

Here, FIG. 6 shows a rear surface of the RFID tag 300. As shown in FIG. 6, a base substrate 210 as shown in FIG. 2 is omitted to further clearly illustrate combination relationships among a tag antenna 220, an IC 230, and the wire 310.

The RFID tag 300 includes the tag antenna 220, the IC 230, and the wire 310.

The wire 310 includes a first end electrically connected to the tag antenna 220 and a second end facing the first end and electrically connected to the IC 230. Thus, the IC 230 is electrically connected to the tag antenna 220.

In detail, the wire 310 includes first and second wires 311 and 313. The first wire 311 is electrically connected to an electrode 221 a of the first tag antenna 221 and a first lead 231 of the IC 230. The second wire 313 is electrically connected to an electrode 223a of a second tag antenna 223 and a second lead 233 of the IC 230.

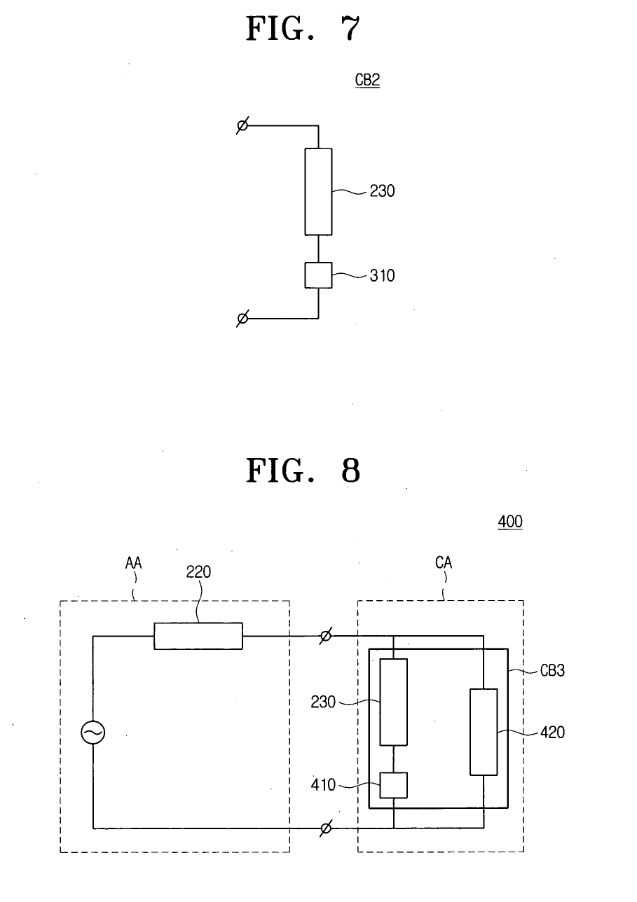

FIG. 7 is a circuit diagram of a chip/bonding part of the RFID tag 300 shown in FIG. 6. Referring to FIGS. 6 and 7, a chip/bonding part CB2 of the RFID tag 300 includes the IC 230 and the wire 310. Since the IC 230 is connected to the wire 310 in series, an impedance of the chip/bonding part CB2 is calculated using Equation 5:
Impedance of Chip/Bonding Part=(R1−jX1)+(R2+jX2) (5)
wherein (R1−jX1) denotes an impedance of the IC 230, and (R2+jX2) denotes an impedance of the wire 310.

Referring to Equation 5, the impedance of the chip/bonding part CB2 is an impedance obtained by adding the impedance (R1−jX1) of the IC 230 to the impedance (R2+jX2) of the wire 310. In other words, the wire 310 is a connection path through which an electric signal is transmitted and received between the tag antenna 220 and the IC 230 and thus has a predetermined impedance like the tag antenna 220 and the IC 230. The impedance (R2+jX2) of the wire 310 is included in a whole impedance of the RFID tag 300 and thus must be considered during designing of the tag antenna 220.

Thus, the impedance of the chip/bonding part CB2 is calculated by adding the impedance (R1−jX1) of the IC 230 to the impedance (R2+jX2) of the wire 310.

The impedance of the chip/bonding part CB2 calculated using Equation 5 is divided into real and imaginary impedances as in Equation 6:
Real Impedance=R1+R2
Imaginary Impedance=−(X1−X2) (6)

When the impedance of the chip/bonding part CB2 is a complex conjugate of the impedance of the tag antenna 220, impedance matching between the tag antenna 220 and the chip/bonding part CB2 can be accurately achieved.

As described above, the impedance of the tag antenna 220 is determined in consideration of the impedance (R1−jX1) of the IC 230 and a parasitic impedance generated by the wire 310, i.e., the impedance (R2+jX2) of the wire 310. That is, the tag antenna 220 according to the present exemplary embodiment is designed in consideration of the impedance of the chip/bonding part CB2 so as to accurately achieve the impedance matching between the tag antenna 220 and the chip/bonding part CB2. Since the RFID tag 300 includes the tag antenna 220 designed through such a process, the impedance matching between the tag antenna 220 and the chip/bonding part CB2 can be accurately achieved. The RFID tag 300 can smoothly transmit data to and/or receive data from the RFID reader 110 and thus extend the read range of the RFID reader 100.

FIG. 8 is a circuit diagram of an RFID tag according to another exemplary embodiment of the present invention. Referring to FIG. 8, an RFID tag 400 according to the present embodiment has the same structure as the RFID tag 200 shown in FIG. 2 except for the addition of wire 410 and a bonding bump 420. The same reference numerals of the RFID tag 400 as those of the RFID tag 200 shown in FIG. 2 denote like elements and thus will not be described herein.

The RFID tag 400 includes a tag antenna 220 and a chip/bonding part CB3 electrically connected to the tag antenna 220. Although not shown in FIG. 8, the RFID tag 400 further includes a substrate 210 on which the tag antenna 220 and the chip/bonding part CB3 are mounted as shown in FIG. 2.

The chip/bonding part CB3 includes an IC 230, a wire part 410 including at least one or more wires, and a bonding bump part 420 including at least one or more bonding bumps. The wire part 410 and the bonding bump part 420 electrically connect the IC 230 to the tag antenna 220.

In the present embodiment, at least one or more wires of the wire part 410 have the same functions and shapes as the first and second wires 311 and 313 shown in FIG. 6, and the at least one or more bonding bumps of the bonding bump part 420 have the same functions and shapes as the first and second bonding bumps 241 and 243 shown in FIG. 3. Thus, detailed descriptions of the wire part 410 and the bonding bump part 420 will be omitted.

When an impedance of the tag antenna 220 is a complex conjugate of an impedance of the chip/bonding part CB3, impedance matching between the tag antenna 220 and the IC 230 can be accurately achieved. Here the impedance of the chip/bonding part CB3 is expressed as in Equation 7:

$$Impedance of Chip \text{/} Bonding Part = Impedance of Tag Element + Impedance of Wire Part + Impedance of Bonding Bump Part \frac{1}{Impedance of Chip \text{/} Bonding Part} = \frac{1}{( R 1 - jX 1 ) + ( R 3 + jX 3 )} + \frac{1}{- jX 4} \frac{1}{Impedance of Chip \text{/} Bonding Part} = \frac{[ ( R 1 - jX 1 ) + ( R 3 + jX 3 ) ] - jX 4}{- jX 4 + ( R 1 - jX 1 ) + ( R 3 + jX 3 )} \qquad ( 7 )$$

wherein (R1−jX1) denotes the impedance of the IC 230, (R3−jX3) denotes the impedance of the wire part 410, and (−jX4) denotes the impedance of the bonding bump part 420.

Referring to Equation 7, the impedance of the chip/bonding part CB3 is obtained by summing the impedance (R1−jX1) of the IC 230, the impedance (R3−jX3) of the wire part 410, and the impedance (−jX4) of the bonding bump part 420.

The impedance of the chip/bonding part CB3 is divided into real and imaginary impedances as in Equation 8:

$$Real Impedance = \frac{( R 1 + R 3 ) X {4}^{2}}{{( R 1 + R 3 )}^{2} + {( X 1 - X 3 + X 4 )}^{2}} \\ Imaginary Impedance = \frac{- X 4 [ {( R 1 + R 3 )}^{2} + ( X 1 - X 3 ) ( X 1 - X 3 + X 4 ) ]}{{( R 1 + R 3 )}^{2} + {( X 1 - X 3 + X 4 )}^{2}} \qquad ( 8 )$$

When the impedance of the tag antenna 230 is designed to be a complex conjugate of the impedance of the chip/bonding part CB3 calculated through such a process, impedance matching between the tag antenna 220 and the chip/bonding part CB3 can be accurately achieved.

As described above, the impedance of the tag antenna 220 is determined in consideration of the impedance (R1−jX1) of the IC 230 and parasitic impedances of the wire part 410 and the bonding bump part 420, i.e., the impedance (R3+jX3) of the wire part 410 and the impedance (−jX4) of the bonding bump part 420.

That is, the tag antenna 220 according to the present exemplary embodiment is designed in consideration of the impedance of the chip/bonding part CB3 so as to accurately achieve the impedance matching between the tag antenna 220 and the chip/bonding part CB3. Since the RFID tag 400 includes the tag antenna 220 designed through such a process, the impedance matching between the RFID antenna 220 and the chip/bonding part CB3 can be accurately achieved. Thus, the RFID tag 400 can smoothly transmit data to and/or receive data from the RFID reader 100 and extend the read range of the RFID reader 100.

As described above, according to the present invention, an RFID tag can include a tag antenna of which impedance is a complex conjugate of an impedance obtained by adding an impedance of an IC to a parasitic impedance generated by bonding the IC to the tag antenna. The impedance of the tag antenna can be calculated in consideration of the impedance of the IC and an impedance generated by bonding the IC to the tag antenna. Thus, the RFID tag can prevent impedance matching between the tag antenna and a chip/bonding part from being inaccurately achieved due to the impedance generated by bonding the IC to the tag antenna.

An RFID system can decrease reflected signals between an RFID reader and the RFID tag and smoothly achieve transmission and reception of data between the RFID reader and the RFID tag. Thus, the RFID system can improve use efficiency of consumed power and extend a read range of the RFID reader.

The foregoing exemplary embodiments are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A radio frequency identification tag (RFID) that wirelessly transmits a signal to and/or receives a signal from an RFID reader using a specific frequency band, the RFID comprising:
a tag antenna that transmits the signal to and/or receives the signal from the RFID reader;
an integrated circuit (IC) electrically connected to the tag antenna that transmits the signal to and/or receives the signal from the tag antenna; and
a bonding part electrically connecting the tag antenna to the IC,
wherein a conjugate of an impedance of the tag antenna is an obtained by adding an impedance of the IC to an impedance of the bonding part.

2. The RFID tag of claim 1, wherein the bonding part comprises one or more bonding bumps bonding the tag antenna to the IC.

3. The RFID tag of claim 2, wherein a sum of the impedances of the IC and the bonding part satisfies an equation as follows:
$$\frac{1}{( Z2 + Z 3 )} = \frac{1}{R 1 - jX 1} + \frac{1}{- jX 2}$$
$$Z 2 + Z 3 = \frac{( R 1 - jX 1 ) ( - jX 1 )}{- jX 2 + ( R 1 - jX 1 )} = \frac{X 1 X 2 + R 1 X 2 j}{- R 1 + ( X 1 + X 2 ) j}$$
$$RZ = \frac{( R 1 ) ( X {2}^{2} )}{R {1}^{2} + {( X 1 + X 2 )}^{2}}$$
$$Im Z = \frac{- X 2 ( R {1}^{2} + ( X 1 ) ( X 1 + X 2 ) )}{R {1}^{2} + {( X 1 + X 2 )}^{2}}$$
wherein Z2 denotes the impedance of the IC, Z3 denotes the impedance of the boding part, (R−jX1) denotes the impedance of the IC, (−jX2) denotes the impedance of the bonding part, RZ denotes a real impedance of an impedance obtained by adding the impedances of the IC to the bonding part, and ImZ denotes an imaginary impedance of the impedance obtained by adding the impedances of the IC to the impedance of the bonding part.

4. The RFID tag of claim 1, wherein the bonding part comprises one or more wires connecting the tag antenna to the IC.

5. The RFID tag of claim 4, wherein a sum of the impedances of the IC and the bonding part satisfies an equation as follows:
Z2+Z3=(R1−jX1)+(R2+jX2)
RZ=R1+R2
ImZ=−(X1−X2)
wherein Z2 denotes the impedance of the IC, Z3 denotes the impedance of the bonding part, (R1−jX1) denotes the impedance of the IC, (R2+jX2) denotes the impedance of the bonding part, RZ denotes a real impedance of the impedance obtained by adding the impedances of the IC to the bonding part, and ImZ denotes an imaginary impedance of an impedance obtained by adding the impedances of the IC to the impedance of the bonding part.

6. The RFID tag of claim 1, wherein the bonding part comprises:
one or more bonding bumps; and
a wire part comprising at least one or more wires connecting the tag antenna to the IC.

7. The RFID tag of claim 6, wherein the sum of the impedances of the IC and the bonding part satisfies an equation as follows:
$$Z 2 + Z 3 = \frac{[ ( R 1 - jX 1 ) + ( R 3 + jX 3 ) ] - jX 4}{- jX 4 + ( R 1 - jX 1 ) + ( R 3 + jX 3 )}$$
$$RZ = \frac{( R 1 + R 3 ) X {4}^{2}}{{( R 1 + R 3 )}^{2} + {( X 1 - X 3 + X 4 )}^{2}}$$
$$Im Z = \frac{- X 4 [ {( R 1 + R 3 )}^{2} ( X 1 - X 3 ) ( X 1 - X 3 + X 4 ) ]}{{( R 1 + R 3 )}^{2} + {( X 1 - X 3 + X 4 )}^{2}}$$
wherein Z2 denotes the impedance of the IC, Z3 denotes the impedance of the bonding part, (R1−jX1) denotes the impedance of the IC, (R3−jX3) denotes an impedance of the wire part, (−jX4) denotes an impedance of the bonding bump part, RZ denotes a real impedance of an impedance obtained by adding the impedances of the IC to the bonding part, and ImZ denotes an imaginary impedance of the impedance obtained by adding the impedances of the IC to the impedance of the bonding part.

8. An RFID system comprising:
an RFID reader that wirelessly transmits a signal using a specific frequency band; and
an RFID tag comprising a tag antenna transmitting the signal to and/or receiving the signal from the RFID reader, an IC electrically connected to the tag antenna to transmit the signal to and/or receive the signal from the tag antenna, and a bonding part electrically connecting the tag antenna to the IC,
wherein a complex conjugate of an impedance of the tag antenna is an impedance obtained by adding an impedances of the IC to an impedance of the bonding part.

9. A method of impedance matching between a radio frequency identification tag (RFID) reader and an RFID tag by determining an impedance of a tag antenna of the RFID tag, the method comprising:
determining an impedance of an integrated circuit (IC), the IC electrically connected to the tag antenna and transmitting a signal to and/or receiving a signal from the tag antenna;
determining an impedance of a binding part that electrically connects the tag antenna to the IC;
determining the impedance of the tag antenna by adding the impedance of the IC to the impedance of the bonding part.
